(19) United States
(12) Patent Application Publication
(10) Pub. No.: US 2012/0211623 A1
(43) Pub. Date: Aug. 23, 2012

(54) BEVERAGE CONTAINER HOLDING DEVICE

(76) Inventor: Craig Leonard Duncan, Moranbah (AU)

(21) Appl. No.: 13/091,432

(22) Filed: Apr. 21, 2011

(30) Foreign Application Priority Data
Feb. 23, 2011 (AU) 2011100211

(51) Int. Cl. A47G 29/00; F16B 2/02

(52) U.S. Cl. 248/289.11

(57) ABSTRACT

A beverage container holding device comprises a beverage container receptacle having a cavity for receiving a beverage container and a mounting bracket or attaching the holding device to a support member. A pivotal joint is provided between the beverage container receptacle and the mounting bracket, allowing the beverage container receptacle to be pivoted relative to the mounting bracket.

### FIELD OF THE INVENTION

The present invention relates to a beverage holding device. In particular, the present invention relates to a beverage holding device for a marine vessel or watercraft.

### BACKGROUND OF THE INVENTION

Recreational marine vessels such as fishing boats have limited places where drink bottles and cans and other handheld items can be placed temporarily. Tables, shelves and other flat surfaces are unsuitable as the items will slide or roll off flat surfaces as the vessel lists from side to side in waves.

When fishing on a vessel, it is common for the fisherman to be enjoying a beverage while waiting for a fish to be hooked on the line. The fisherman may need to put down the beverage to bait the line or attend to other duties. Once a fish is hooked on the line, the fisherman then needs both hands immediately to operate the fishing rod. In such circumstances, it can be difficult to find a suitable place to stow the beverage while the fisherman operates the fishing rod or baits the line. By the time the fish has been reeled in or the line is baited, the beverage is often lost in the commotion on board the vessel.

### OBJECT OF THE INVENTION

It is an object of the present invention to substantially overcome or at least ameliorate one or more of the above disadvantages, or to provide a useful alternative.

### SUMMARY OF THE INVENTION

In a first aspect, the present invention provides a beverage container holding device comprising:
a beverage container receptacle having a cavity for receiving a beverage container;
a mounting bracket for attaching the holding device to a support member; and
a pivotal joint between the beverage container receptacle and the mounting bracket, allowing the beverage container receptacle to be pivoted relative to the mounting bracket.

In a preferred embodiment, the pivotal joint comprises:
a circular race provided on one of the beverage container receptacle and the mounting bracket, the circular race having a plurality of depressions in the race; and
at least one resiliently mounted boss provided on the other of the mounting bracket and the beverage container receptacle, the at least one boss being biased to protrude from the mounting bracket or beverage container receptacle;
wherein the mounting bracket is pivotally mounted to the beverage container receptacle so that when the beverage container receptacle is pivoted relative to the mounting bracket, the boss travels around the circular race and projects into each depression in the circular race when the boss is aligned with a depression, thereby providing a plurality of positions, in which to retain the beverage container receptacle relative to the mounting bracket.

The circular race is preferably provided on an outer surface of the beverage container receptacle and the at least one boss is provided on the mounting bracket.

Preferably, the pivotal joint includes two resiliently mounted bosses diametrically opposed across the pivotal mounting of the mounting bracket. Further preferably, the two bosses are biased by way of leaf springs formed in a circular mounting surface of the mounting bracket.

In a preferred embodiment, the circular race is provided on the outer end of a raised stub projecting from an outer surface of the beverage container receptacle. Preferably, the raised stub has a central spindle coaxial with the circular race, the central spindle having a central mounting hole for pivotally mounting the mounting bracket.

The mounting bracket preferably comprises:
an inner clamp member having a circular mounting surface with a central aperture for mounting on the central spindle of the raised stub and an inner clamp surface;
a pair of said bosses diametrically opposed across the central aperture and resiliently mounted on the mounting surface by way of leaf springs formed in the mounting surface;
an outer clamp member having an outer clamp surface, the outer clamp member being releasably securable to the inner clamp member such that the outer clamp surface opposes the inner clamp surface for clamping the mounting bracket to a support member.

Preferably, the beverage holding device further comprises a circular mounting surface washer, the mounting surface washer having a pair of diametrically opposed cutouts adapted to accommodate the bosses when arranged between the raised stub and the circular mounting surface.

Further preferably, the inner clamp member includes a screw fastener, a fastener washer and a washer seat for receiving the fastener washer wherein the screw fastener is adapted to pass through the fastener washer, the central aperture of the circular mounting surface, the mounting surface washer and be screwed into the central mounting hole of the central spindle to pivotally mount the mounting bracket to the beverage container receptacle.

In a preferred embodiment, a base of the beverage container receptacle is provided with one or more drainage ports to allow liquid to drain from the cavity.

In a further aspect, the present invention provides a beverage container holding device comprising:
a beverage container receptacle having a cavity for receiving a beverage container;
a mounting bracket for attaching the holding device to a support member;
a circular race provided on one of a raised stub on an outer surface of the beverage container receptacle and the mounting bracket, the circular race having a plurality of depressions in the race; and
at least one resiliently mounted boss provided on the other of the mounting bracket and the raised stub, the at least one boss being biased to protrude from the mounting bracket or the raised stub;
wherein the mounting bracket is pivotally mounted to the beverage container receptacle so that when the beverage container receptacle is pivoted relative to the mounting bracket, the boss travels around the circular race and projects into each depression in the circular race when the boss is aligned with a depression, thereby providing a plurality of positions, in which to retain the beverage container receptacle relative to the mounting bracket.

### BRIEF DESCRIPTION OF THE DRAWINGS

A preferred embodiment of the invention will now be described by way of specific example with reference to the accompanying drawings, in which:

FIG. 1 depicts a fully assembled beverage container holding device;

FIG. 2 depicts a beverage container receptacle of the beverage container holding device of FIG. 1;

FIG. 3 depicts an inner clamp member of a mounting bracket of the beverage container holding device of FIG. 1;

FIG. 4 is a rear view of the inner clamp member depicted in FIG. 3;

FIG. 5 depicts an outer clamp member of a mounting bracket of the beverage container holding device of FIG. 1;

FIG. 6 depicts a first washer of the beverage container holding device of FIG. 1; and

FIG. 7 depicts a second washer of the beverage container holding device of FIG. 1.

### DETAILED DESCRIPTION OF THE PREFERRED EMBODIMENTS

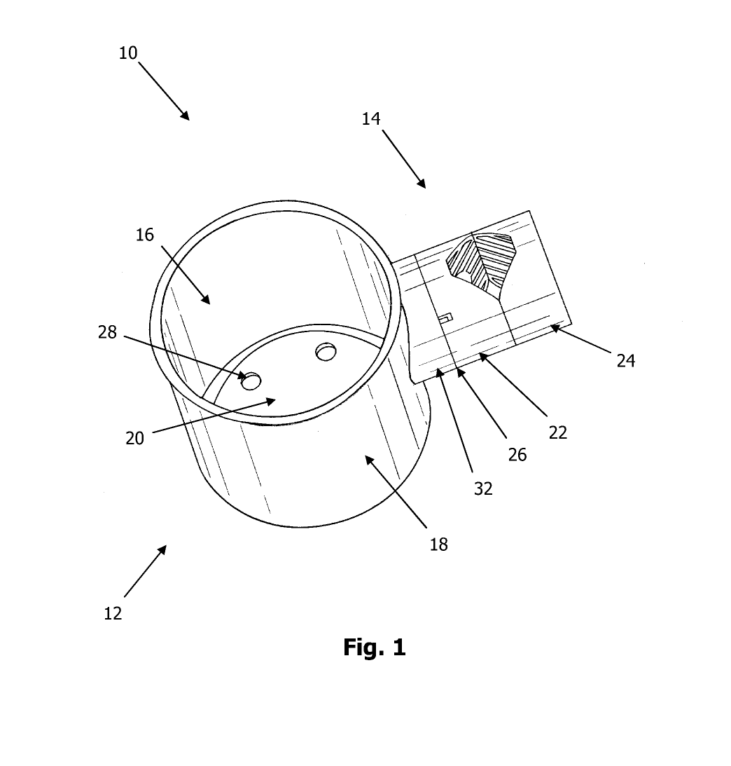

FIG. 1 depicts a beverage container holding device 10 that is adapted to be mounted on a support member such as a rail of a marine vessel or a camping chair. The holding device 10 includes a beverage container receptacle 12 and a mounting bracket 14 for mounting the holding device 10 to the support member. The beverage container receptacle 12 has a cylindrical cavity 16 for receiving a beverage container, a cylindrical outer surface 18 and a base 20. The mounting bracket 14 has an inner clamp member 22 and an opposing outer clamp member 24, which are adapted to clamp the support member between the inner clamp member 22 and the outer clamp member 24. A pivotal joint 26 is provided between the beverage container receptacle 12 and the mounting bracket 14 to allow the beverage container receptacle 12 to be pivoted relative to the mounting bracket 14.

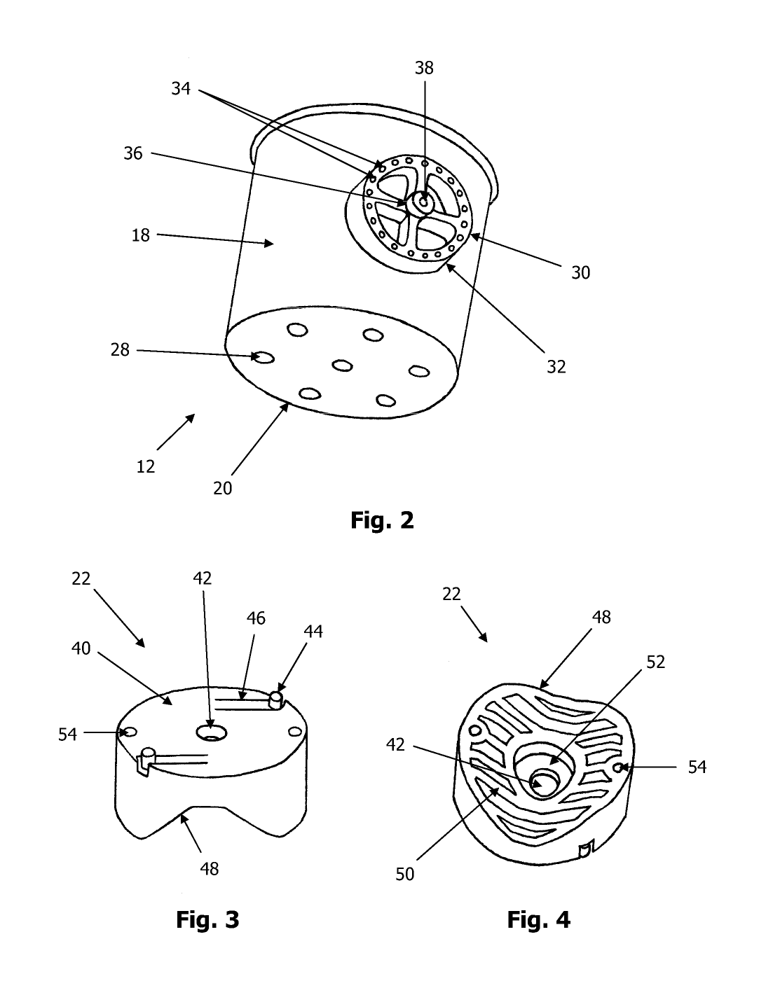

FIGS. 2 to 6 display individual components of the beverage container holding device 10 in isolation. FIG. 2 depicts the beverage container receptacle 12, which is provided with a plurality of drainage ports 28 in the base 20 to allow liquid to drain from the cavity 16. A circular race 30 is provided on a raised stub 32 on an outer surface of the beverage container receptacle 12. The circular race 30 is provided with a plurality of hemispherical depressions 34 spaced around the circular race 30. The raised stub 32 has a central spindle 36 coaxial with the circular race 30, the central spindle 36 having a central mounting hole 38. The cavity 16 of beverage container receptacle 12 is sized to fit a standard sized drink can or bottle with a neoprene or foam cooler around the can or bottle.

FIGS. 3 and 4 depict the inner clamp member 22 of the mounting bracket 14. The inner clamp member 22 has a circular surface 40 with a central aperture 42 which is adapted to receive the central spindle 36. The inner clamp member 22 is provided with a pair of diametrically opposed bosses 44 resiliently mounted by way of leaf springs 46 formed in the circular surface 40. The bosses 44 are biased by the leaf springs 46 so as to protrude from the circular surface 40 and to be compressible into the circular surface 40. The inner clamp member 22 has an inner clamp jaw 48 with a plurality of ribs 50 and a washer seat 52 around the central aperture 42. A pair of inner mounting holes 54 are also provided in the inner clamp member 22.

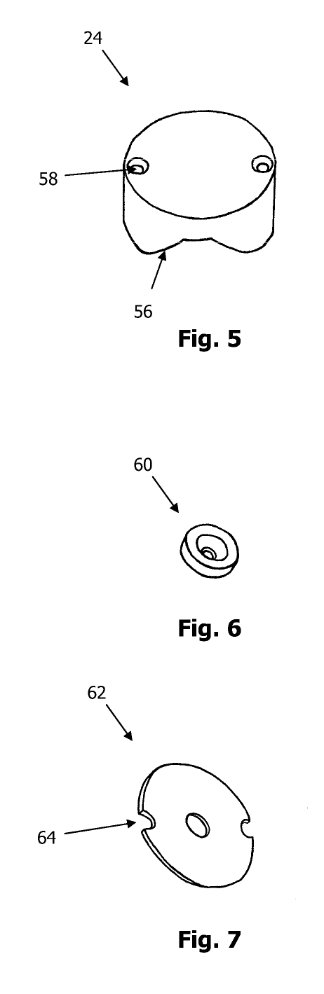

FIG. 5 depicts the outer clamp member 24 of the mounting bracket 14. The outer clamp member 24 has an outer clamp jaw 56, which is complimentary to the inner clamp jaw 48 and a pair of outer mounting holes 58.

FIG. 6 depicts a first washer 60 that is adapted to sit in the washer seat 52 of the inner clamp member 22.

FIG. 7 depicts a second washer 62 having a pair of diametrically opposed cutouts 64 shaped to accommodate the pair of bosses 44 when arranged on the circular surface 40 of the inner clamp member 22.

With the first washer arranged in the washer seat 52 and the second washer 62 arranged on the circular surface 40, the inner clamp member 22 is mounted to the raised stub 32 on the beverage container receptacle 12, by receiving the central spindle 36 in the central aperture 42 and securing the inner clamp member 22 in place by way of a screw or bolt through the central mounting hole 38. This provides the pivotal joint 26 between the beverage container receptacle 12 and the mounting bracket 14. The inner clamp member 22 is then arranged against a support member and the outer clamp member 24 is secured on the opposite side of the support member by way of screws or bolts through the pair of outer mounting holes 58 and inner mounting holes 54.

In this way, the beverage container receptacle 12 is pivotally mounted to the support member by the mounting bracket 14. When the beverage container receptacle 12 is forcibly pivoted relative to the mounting bracket 14, the bosses 44 are depressed into the circular surface 40 as they pass between depressions 34 in the circular race 30. Once the bosses 44 are aligned with new depressions 34, the leaf springs 46 press the bosses 44 into the depressions 34, locking the beverage container receptacle 12 in the new orientation. Accordingly, the beverage container holding device 10 provides a plurality of positions, in which to retain the beverage container receptacle 12 relative to the mounting bracket 14.

In an alternative arrangement, the circular race 30 may be provided on the mounting bracket 14 and the bosses 44 may be provided on the beverage container receptacle 12. In this arrangement, the functioning of the pivotal joint 26 would remain the same as described above.

The beverage container holding device 10 provides a convenient storage location for a beverage container that can be secured to a support member such as rail of a marine vessel or camp chair and set by the user in any one of a plurality of orientations.

Multiple beverage container holding devices 10 can be arranged at different locations around a marine vessel to provide a plurality of convenient locations to store a beverage container when necessary.

The beverage container holding device 10 is typically manufactured from UV stabilised plastic, stainless steel or other suitable material.

Although the invention has been described with reference to specific examples, it will be appreciated by those skilled in the art that the invention may be embodied in many other forms.

1. A beverage container holding device comprising:
a beverage container receptacle having a cavity for receiving a beverage container;
a mounting bracket for attaching the holding device to a support member; and
a pivotal joint between the beverage container receptacle and the mounting bracket, allowing the beverage container receptacle to be pivoted relative to the mounting bracket.

2. The beverage container holding device of claim 1 wherein the pivotal joint comprises:
a circular race provided on one of the beverage container receptacle and the mounting bracket, the circular race having a plurality of depressions in the race; and
at least one resiliently mounted boss provided on the other of the mounting bracket and the beverage container receptacle, the at least one boss being biased to protrude from the mounting bracket or beverage container receptacle;
wherein the mounting bracket is pivotally mounted to the beverage container receptacle so that when the beverage container receptacle is pivoted relative to the mounting bracket, the boss travels around the circular race and projects into each depression in the circular race when the boss is aligned with a depression, thereby providing a plurality of positions, in which to retain the beverage container receptacle relative to the mounting bracket.

3. The beverage container of claim 2 wherein the circular race is provided on an outer surface of the beverage container receptacle and the at least one boss is provided on the mounting bracket.

4. The beverage container of claim 3 wherein the pivotal joint includes two resiliently mounted bosses diametrically opposed across the pivotal mounting of the mounting bracket.

5. The beverage container holding device of claim 4 wherein the two bosses are biased by way of leaf springs formed in a circular mounting surface of the mounting bracket.

6. The beverage container holding device of claim 3 wherein the circular race is provided on the outer end of a raised stub projecting from an outer surface of the beverage container receptacle.

7. The beverage container holding device of claim 6 wherein the raised stub has a central spindle coaxial with the circular race, the central spindle having a central mounting hole for pivotally mounting the mounting bracket.

8. The beverage container holding device of claim 7 wherein the mounting bracket comprises:
an inner clamp member having a circular mounting surface with a central aperture for mounting on the central spindle of the raised stub and an inner clamp surface;
a pair of said bosses diametrically opposed across the central aperture and resiliently mounted on the mounting surface by way of leaf springs formed in the mounting surface;
an outer clamp member having an outer clamp surface, the outer clamp member being releasably securable to the inner clamp member such that the outer clamp surface opposes the inner clamp surface for clamping the mounting bracket to a support member.

9. The beverage container holding device of claim 8 further comprising a circular mounting surface washer, the mounting surface washer having a pair of diametrically opposed cutouts adapted to accommodate the bosses when arranged between the raised stub and the circular mounting surface.

10. The beverage container holding device of claim 9 wherein the inner clamp member includes a screw fastener, a fastener washer and a washer seat for receiving the fastener washer wherein the screw fastener is adapted to pass through the fastener washer, the central aperture of the circular mounting surface, the mounting surface washer and be screwed into the central mounting hole of the central spindle to pivotally mount the mounting bracket to the beverage container receptacle.

11. The beverage container holding device of claim 1 wherein a base of the beverage container receptacle is provided with one or more drainage ports to allow liquid to drain from the cavity.

12. The beverage container holding device of claim 2 wherein a base of the beverage container receptacle is provided with one or more drainage ports to allow liquid to drain from the cavity.

13. A beverage container holding device comprising:
a beverage container receptacle having a cavity for receiving a beverage container;
a mounting bracket for attaching the holding device to a support member;
a circular race provided on one of a raised stub on an outer surface of the beverage container receptacle and the mounting bracket, the circular race having a plurality of depressions in the race; and
at least one resiliently mounted boss provided on the other of the mounting bracket and the raised stub, the at least one boss being biased to protrude from the mounting bracket or the raised stub;
wherein the mounting bracket is pivotally mounted to the beverage container receptacle so that when the beverage container receptacle is pivoted relative to the mounting bracket, the boss travels around the circular race and projects into each depression in the circular race when the boss is aligned with a depression, thereby providing a plurality of positions, in which to retain the beverage container receptacle relative to the mounting bracket.
